(19) United States
(12) Patent Application Publication
(10) Pub. No.: US 2014/0290496 A1
(43) Pub. Date: Oct. 2, 2014

(54) COOKING CONTAINMENT BARRIER

(71) Applicant: Candy Coldsmith, Shippersburg, PA (US)

(72) Inventor: Candy Coldsmith, Shippersburg, PA (US)

(21) Appl. No.: 13/855,169

(22) Filed: Apr. 2, 2013

(51) Int. Cl. A47J 43/18

(52) U.S. Cl. CPC A47J 43/18
USPC 99/324

(57) ABSTRACT

A cooking containment barrier for use with a cooking product comprising: a screen, where the screen is made from a mesh material; and a plurality of anchoring means, where the plurality of anchoring means secure the screen over an opening into an inner cavity of the cooking products to ensure that the inner contents of the cavity remain in place. The cooking containment barrier may be square or circular shaped to completely cover the opening.

### BACKGROUND OF THE INVENTION

1. Field of the Invention

The present invention relates to a barrier placed over an opening into a cavity of a cooking fowl to contain the inner food product while cooking

2. Description of Related Art

When preparing a turkey, chicken or other culinary bird, many people choose to stuff the bird with a variety of ingredients. Common ingredients are bread, celery, onion, mushrooms, peppers, meat, eggs, and spices. The ingredients are mixed together, cooked and then placed into the bird. During the cooking process, the stuffing absorbs the juices released from the bird to impart the poultry flavor into the stuffing ingredients. The final results are a moist and delicious side dish to accompany the turkey or chicken. The stuffing process may also be accomplished with other food products like chicken breasts, rolled roasts or steaks, fish, peppers, gourds and mushrooms. The stuffing ingredients are typically changed to compliment the exterior containing food, but the flavor imparting goal is always accomplished.

Many times while cooking, the chef must check the temperature of the bird and the stuffing to ensure that thorough cooking is attained. To do this, the bird is removed from the oven and a thermometer is inserted into the breast and the cavity with the stuffing. Once the ideal temperature is reached the bird is removed and allowed to cool. A problem typically encountered is that when the bird is removed from the oven the stuffing tends to fall out into the cooking pan. After repeated temperature checks, this causes a lot of stuffing to end up in the pan, which is then discarded as waste.

Therefore it would be beneficial in the art to provide a barrier to contain the stuffing within the bird. It would also be desirable in the art to provide a barrier that allows the chef to check the temperature without having to remove the barrier.

### SUMMARY OF THE INVENTION

In view of the foregoing disadvantages inherent in the prior art, the general purpose of the present invention is to provide a cooking containment barrier for use with a cooking product, configured to include all of the advantages of the prior art, and to overcome the drawbacks inherent therein.

Accordingly, an object of the present invention is to provide a barrier that is positioned over the stuffing placed within a food product to ensure that the stuffing does not fall out while cooking.

Another object of the present invention is to provide a barrier that is made from a mesh or screen material to enable a user to check the temperature of the stuffing without having to remove the barrier.

To achieve the above objects, in an aspect of the present invention, a cooking containment barrier is described comprising: a screen, where the screen is made from a mesh material; and a plurality of anchoring means, where the plurality of anchoring means secure the screen over an opening into an inner cavity of the cooking products to ensure that the inner contents of the cavity remain in place. The cooking containment barrier may be square or circular shaped to completely cover the opening.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a cooking containment barrier in accordance with an exemplary embodiment of the present invention; and

FIG. 2 depicts a perspective view of a cooking containment barrier in accordance with an alternative embodiment of the present invention.

Like reference numerals refer to like parts throughout the description of several views of the drawings.

### DETAILED DESCRIPTION OF THE DRAWINGS

The present invention relates to a barrier placed over an opening into a cavity of a cooking fowl to contain the inner food product while cooking The present invention provides a cooking containment barrier which keeps stuffing inside a cooking bird. The cooking containment barrier includes a mesh screen that is secured in placed with anchors around the edges. The anchors pin the screen over the cavity opening after all of the stuffing ingredients have been inserted. The cooking containment barrier ensures that the stuffing does not escape and spill into the pan while cooking.

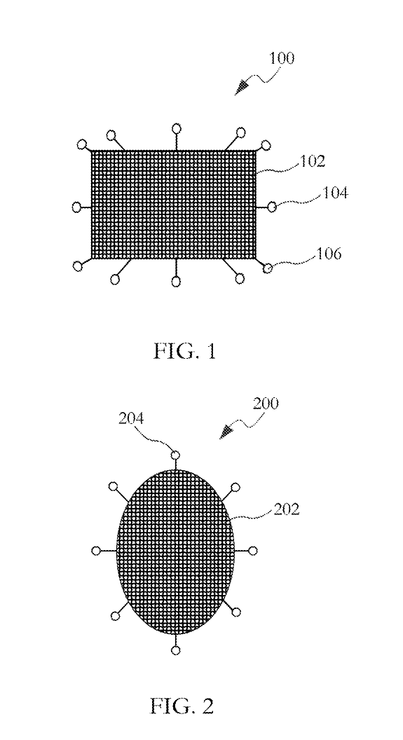

Turning now descriptively to the drawings, referring to FIG. 1, a cooking containment barrier 100 is shown in accordance with an exemplary embodiment of the present invention. The cooking containment barrier 100 includes a screen 102 that is positioned over an opening into a cavity of a cooking product. The screen 102 may be a flexible mesh material that easily stretches and bends to completely cover the opening. As illustrated in FIG. 1 the screen 102 may be square or rectangular shaped. The screen 102 is made from a mesh material to allow the dry heat of an oven to cook the inner contents of the cavity. Also, the mesh enables a user to insert a thermometer through the screen 102 into the cavity to check the temperature of the inner ingredients. The screen 102 may be reusable, and made from a material that does not absorb or impart flavors onto the different food products is touches. Alternatively, the screen 102 may be disposable, and packaged in multi-packs for extra convenience.

Around the screen 102 are a plurality of anchoring means 104, 106. Around the edges of the screen 102 are a plurality of lateral anchoring means 104, and at the corners of the screen is a plurality of corner anchoring means. 106. The anchoring means 104, 106 may be pins, staples, stakes, toothpicks or the like. The anchoring means 104, 106 insert through the screen and into the surrounding flesh of the cavity opening. Both the screen 102 and the anchoring means 104, 106 are able to withstand high temperatures to ensure that they do not melt or burn during the cooking process.

Referring now to FIG. 2, a perspective view of a cooking containment barrier 200 is shown in accordance with an alternative embodiment of the present invention. The cooking containment barrier 200 includes a screen 202. FIG. 2 illustrates the screen 202 in a circular or oval shape. Around the edge of the screen 202 are a plurality of peripheral anchoring means 204. The screen 202 and anchoring means 204 are made from similar materials as the first embodiment, but the screen 202 comprises a rounded shape ideal or round openings.

Besides using the cooking containment screen for poultry, it may also be used with roasts, fish, rolled means, stuffed peppers, gourds, mushrooms or any other stuffed foods that risk their inner ingredients from spilling. To use, the user simply positioned the screen over the opening to the cavity of the food product. The anchoring means are then inserted through the screen and into the food product's flesh to secure all edges of the screen. Once the screen is in place the user cooks the food product. After cooking the anchoring means and screen are removed to empty the inner ingredients.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A cooking containment barrier for use with a cooking product comprising:
a. a screen, where the screen is made from a mesh material; and
b. a plurality of anchoring means, where the plurality of anchoring means secure the screen over an opening into an inner cavity of the cooking products to ensure that a plurality of ingredients within the cavity remain in place.

2. The cooking containment barrier according to claim 1, where the screen is square shaped.

3. The cooking containment barrier according to claim 2, where the square screen includes a plurality of corner anchoring means and a plurality of lateral anchoring means.

4. The cooking containment barrier according to claim 1, where the screen is circular shaped.

5. The cooking containment barrier according to claim 4, where the circular screen includes a plurality of peripheral anchoring means.

6. The cooking containment barrier according to claim 1, where the screen is reusable.

7. The cooking containment barrier according to claim 1, where the plurality of anchoring means are one of at least pins, toothpicks, staples or stakes.
